(19) United States
(12) Patent Application Publication
(10) Pub. No.: US 2001/0049814 A1
(43) Pub. Date: Dec. 6, 2001

(54) Automatic logic design supporting method and apparatus

(76) Inventors: Kazuhiko Matsumoto, Kawasaki (JP); Kazuhiro Adachi, Hadano (JP); Tomoko Ishida, Tokyo (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/811,402

(22) Filed: Mar. 20, 2001

(30) Foreign Application Priority Data
May 24, 2000 (JP) 2000-157965

(51) Int. Cl. G06F 17/50

(52) U.S. Cl. 716/10; 716/9; 716/11

(57) ABSTRACT

The problem of the disclosed technique is to realize an automatic logic design supporting method and apparatus capable of laying out a circuit of logic synthesis result so as to be able to satisfy delay constraints without changing the logic structure.

For this reason, one solution means is to provide a layout program controlling information unit including a cell grouping process for placing a plurality of cells within a logic circuit in a logic circuit obtained by processing through the use of a logic synthesis unit to be adjacent to each other, and generating an adjacent placement instruction for realizing wiring between cells made adjacent to each other in local inter-connect, and a wire length budgeting process for giving a wire length budget to nets within the logic circuit so as to be able to satisfy delay constraints. In the layout process, placement and routing will be performed in accordance with these adjacent placement instruction and wire length budget. Thereby, re-design of the previous process of the design can be avoided to reduce the number of design man-hour of LSI.

### BACKGROUND OF THE INVENTION

1. Field of the Invention

The present invention relates to an automatic logic design supporting method and apparatus, and more particularly to an automatic logic design supporting method and apparatus having a layout program controlling information generating process for controlling the layout so as to be able to satisfy delay constraints.

2. Description of the Prior Art

Along with minimization of LSI in recent years, a ratio of wire delay to total delay has increased and the wire delay ratio has exceeded 50%. Therefore, at the time of logic synthesis, it has become necessary to sufficiently take into consideration not only a number of stages of gate or gate delay, but also wire delay. However, since the logic synthesis process is a previous process to layout (placement and routing), and placement and routing of cell have not been determined, the delay is calculated through the use of virtual wire length at the time of logic synthesis to thereby optimize the delay. This virtual wire length is statistical data to be obtained from the past statistics, and is uniformly determined depending upon size of the circuit, a fan-out number of the net at the time of logic synthesis.

On the other hand, since the virtual wire length used in the logic synthesis process cannot be realized in the layout process, the delay constraints cannot be satisfied after the layout although the delay constraints have been satisfied in the delay calculation in logic synthesis. In other words, an alienation occurs between delay calculation result in logic synthesis and delay calculation result using actual wire length after the layout. As a result, it becomes necessary to iterate the layout and the logic synthesis again. Further, since the logic structure is changed by iterating the logic synthesis again, size of the logic circuit is also changed, and it becomes necessary to iterate the floorplan again. Since these redesigns occur frequently, there is the problem that the design cannot be completed easily.

Conventionally, as a method to solve this sort of problems, there has, in Japanese Patent Laid-Open Application No. 10-340293, been disclosed a first method in which a layout is performed once, virtual wire length is presumed again from the result, and re-logic analysis and re-layout are performed through the use of the newly presumed virtual wire length. Also, there has, in Japanese Patent Laid-Open Application No. 5-101140, been disclosed a second method in which a budget for wire length is given to each net of the logic circuit and a layout is performed with the budget value or less.

In the first method, however, the virtual wire length is changed from a presumed value based on the past design to a presumed value based on the tentative layout result of the present design circuit, whereby in the average of the entire circuit, the alienation between the delay calculation result in logic synthesis and the delay calculation result using actual wire length after the layout becomes smaller, and the delay violations are also improved. However, the alienation between the virtual wire length and the actual wire length of the individual nets cannot be still solved, and therefore, the problem of redesign occurred cannot be solved. Also, in the second method, it makes no concrete mention of how budgeting should be done.

### SUMMARY OF THE INVENTION

It is an object of the present invention to solve the problem of the alienation between the delay calculation result at the time of logic synthesis and the delay calculation result using actual wire length after the layout, and to provide an automatic logic design supporting method for promoting cooperation between the logic synthesis process and the layout process in order to restrain the number of times of occurrence of re-design. Also it is also an object to provide an automatic logic design supporting apparatus using the method, and to provide products designed by using this apparatus.

In order to solve the above-described problems, an automatic logic design supporting method according to the present invention comprises: a logic design input process for inputting function description of a logic circuit; a logic synthesis process for synthesizing a logic circuit from the function description; a layout program controlling information generating process for generating layout controlling information for laying out the logic circuit so as to be able to satisfy the delay constraints; and a layout process for laying out the logic circuit based on the layout program controlling information.

The layout program controlling information generating process preferably includes a cell grouping process for placing a plurality of cells within a logic circuit to be adjacent to each other, and for generating an adjacent placement instruction for realizing wiring between cells adjacent to each other in local inter-connect.

Further, the layout program controlling information generating process may include a wire length budgeting process for giving a wire length budget to a net in the logic circuit to lay out in such a manner that the layout process becomes equal to or less than the wire length given to the net.

Also, the layout program controlling information generating process is also capable of including a cell grouping process for placing a plurality of cells within a logic circuit to be adjacent to each other to generate an adjacent placement instruction for realizing wiring between cells made adjacent to each other in local inter-connect, and a wire length budgeting process forgiving wire length to nets within the logic circuit for laying out in such a manner that the layout process becomes equal to or less than the wire length given to the net.

The cell grouping process preferably extracts a partial circuit, which conforms to a cell grouping rule instructed from the outside, from within the logic circuit in accordance with the rule for generating an adjacent placement instruction to the partial circuit.

Also, the cell grouping process can include a process for changing a driving ability of a cell which has further received an adjacent placement instruction under a condition to satisfy the delay constraints.

The wire length budgeting process preferably allots such a wire length budget as to satisfy the delay constraints to all nets or some nets in the logic circuit.

The wire length budgeting process may allot a wire length budget to all nets in the logic circuit so as to follow designated wire length distribution.

The wire length budgeting process may be able to designate a wire length budget to some nets in the logic circuit in an interactive manner.

An automatic logic design supporting apparatus according to the present invention comprises: logic design input means for inputting function description of a logic circuit; logic synthesis means for synthesizing a logic circuit from the function description; layout program controlling information generating means for generating layout program controlling information for laying out the logic circuit so as to be able to satisfy delay constraints; and layout means for laying out the logic circuit based on the layout program controlling information.

If this automatic logic design supporting apparatus is further provided with a graphic user interface consisting of a display device for displaying a logic circuit diagram and a wire length distribution diagram, and an input device such as a keyboard and a mouse for designating the wire length, that is, a graphic terminal, the wire length budget can be preferably designated in an interactive manner.

A semiconductor apparatus according to the present invention is characterized by having been designed through the use of the automatic logic design supporting apparatus.

The various objects and other objects of the present invention will become apparent from the following detailed description and the accompanying claims with reference to the accompanying drawings.

### BRIEF DESCRIPTION OF THE DRAWINGS

FIG. 1 is a view showing an overall structure of an automatic logic design supporting system according to the present invention;

FIG. 2 is a view showing a flow of process of a layout program controlling information generating process unit in the automatic logic design supporting system according to the present invention;

FIG. 3 is a view showing a logic circuit for explaining a cell grouping process in the layout program controlling information generating process;

FIG. 4 is a view showing a logic circuit for explaining details of the cell grouping process in the layout program controlling information generating process;

FIG. 5 is a view showing a logic circuit for explaining a driving ability changing process;

FIG. 6 is a view showing layout process result of the logic circuit shown in FIG. 4;

FIG. 7 is a view showing net wire length distribution of the net in the logic circuit;

FIG. 8 is a view showing a flow of process for giving short wire length in wire length budgeting;

FIG. 9 is a view showing a flow of process for giving long wire length in wire length budgeting;

FIG. 10 is a view showing an example of the process for giving short wire length in wire length budgeting;

FIG. 11 is a view showing an example of the process for giving long wire length in wire length budgeting; and

FIG. 12 is a view showing the layout process result of the logic circuit shown in FIG. 10.

### DETAILED DESCRIPTION OF THE PREFERRED EMBODIMENTS

Hereinafter, with reference to the accompanying drawings, the detailed description will be made of preferred embodiments of the present invention.

In a large-scale LSI design, LSI chips are generally divided into a plurality of blocks for each function for designing. They are divided into blocks such as, for example, CPU (Central Processing Unit) and memory controller (may be further divided into smaller functions). Logic description and logic synthesis are performed in units of blocks divided, and finally layout (placement and routing) is collectively performed.

It is experimentally known that total wire length of an intra-block net and wire length distribution of the intra-block net are determined by the area of this block. For this reason, in the logic synthesis, the delay calculation has been performed using virtual wire length to be determined by (total wire length)/(intra-block net number).

The block area is determined by roughly estimation in some cases and it can be determined by the temporary logic synthesis results. An embodiment of the present invention to be described hereinafter is predicated on that a block area has been already determined and virtual wire length and wire length distribution have been given for each block.

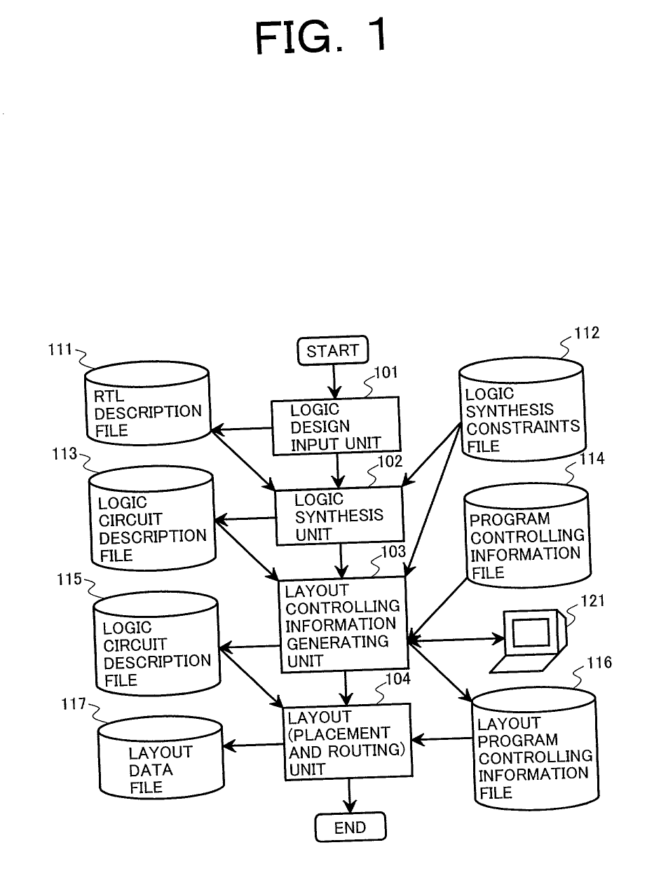

FIG. 1 is a view showing a structure of an automatic logic design supporting system according to the present invention, and the automatic logic design supporting system is constructed of: a logic design input unit 101; a logic synthesis unit 102; a layout controlling information generating unit 103; and a layout unit 104.

The logic design input unit 101 prepares a register transfer level (RTL) description file 111 based on the function description.

The logic synthesis unit 102 performs a logic synthesis process with the RTL description file 111 and a logic synthesis constraints file 112, in which design constraints of delay, area and so on have been described, as input to output a logic circuit description file 113, which is a net list at gate level.

The layout controlling information generating unit 103 performs the process with the logic circuit description file 113, the logic synthesis constraints file 112, and a program controlling information file 114, which is control information of the layout controlling information generating unit 103, as input to output a logic circuit description file 115 and a layout program controlling information file 116, which have been updated. Also, it is possible to perform an interactive layout controlling information generating process through the use of a terminal 121.

The layout unit 104 performs a placement and routing process, that is, layout process with the logic circuit description file 115 and the layout program controlling information file 116 as input to output a layout data file 117.

Hereinafter, the detailed description will be made of each processing unit 101 to 104.

Logic Design Input Unit 101:

Here, the RTL description is directly inputted in a hardware description language to prepare the RTL description file 111, or a logic diagram is inputted through the use of a schematic editor to convert it into the RTL description file 111.

Logic Synthesis Unit 102:

Logic synthesis is performed with the RTL description file 111 and the logic synthesis constraints file 112, in which the delay constraints, area constraints and so on have been described, as input to output the logic circuit description file 113, which is a net list at gate level. In this logic synthesis process, the delay calculation is performed based on the virtual wire length, and logic optimization is performed so as to satisfy the logic synthesis constraints as far as possible. The virtual wire length is statistical data obtained from the past design, and in logic synthesis, it is uniformly determined depending on such as the size, fan-out number of the logic circuit.

As a result of this logic synthesis process, a path between flip-flop (FF) or a path between a block input-output port and FF can be classified under the following three types: a first path which satisfies the delay constraints in delay calculation using virtual wire length; a second path, which does not satisfy the delay constraints in delay calculation using virtual wire length, but satisfies the delay constraints assuming all wire length of nets on the path to be zero; and a third path, which does not satisfy the delay constraints as a result of delay calculation using virtual wire length, but does not satisfy the delay constraints even if all wire lengths of nets on the path are assumed to be zero.

Of these paths, since the third path is not capable of satisfying the delay constraints however the layout may be performed unless the driving ability of cells on the path is changed or the logic structure is changed, it is necessary to iterate the logic synthesis process of the logic synthesis unit 102 or to directly change the logic circuit description file 113 by changing the RTL description file 111 or changing the logic synthesis constraints file 112.

In this respect, since the layout controlling information generating unit 103, which is the major portion of the present invention, is predicated on that these logic re-synthesis and logic circuit description change have been completed, the description will be made of the present embodiment on the assumption that there is not present the third path.

Layout Controlling Information Generating Unit 103:

With the logic circuit description file 113, the logic synthesis constraints file 112, and the program controlling information file 114, which is control information of the layout controlling information generating unit 103, as input, the process is performed to output a logic circuit description file 115 and a layout program controlling information file 116, which have been updated. Also, it is also possible to perform an interactive process through the use of a terminal 121.

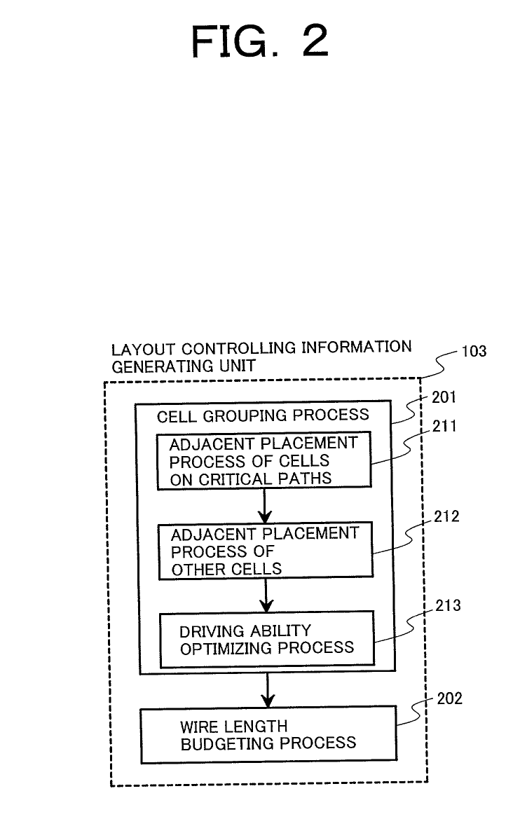

FIG. 2 is a flowchart showing the process of the layout program controlling information generating process unit 103. The layout controlling information generating unit 103 performs two processes: the cell grouping process 201 and wire length budgeting process 202. These two processes may be both executed in order of the cell grouping process 201 and wire length budgeting process 202, and only either of them may be executed, but in the present embodiment, the description will be made of a case where both are executed hereinafter.

Cell Grouping Process 201:

The cell grouping process further consists of three processes: firstly an adjacent placement process 211 of cells on a critical path; secondly an adjacent placement process 212 of other cells; and thirdly a driving ability optimizing process 213. Hereinafter, the description will be made of these three processes 211, 212 and 213.

Adjacent Placement Process 211 of Cells on the Critical Path:

An object of this process is to reduce the wire delay by placing cells on a path, in which delay violation occurs, adjacent to each other. First, from the delay calculation result, a path having the heaviest degree of delay violation is selected. The cells are selected in order while fan-out trace is being performed with a cell of the path nearest to the input side as a starting point to instruct adjacent placement of the cell within such a range as to satisfy the adjacent placement constraints described in the program controlling information file 114. In this case, in the adjacent placement constraints, there are described a number of cells within one group, the upper limit of number of stages, the maximum fan-out number of nets within the group and so on. In this case, the adjacent placement constraints are assumed to be given in which the number of cells is 6 or less, the number of stages is three stages or less, the maximum fan-out number of net is 2 or less.

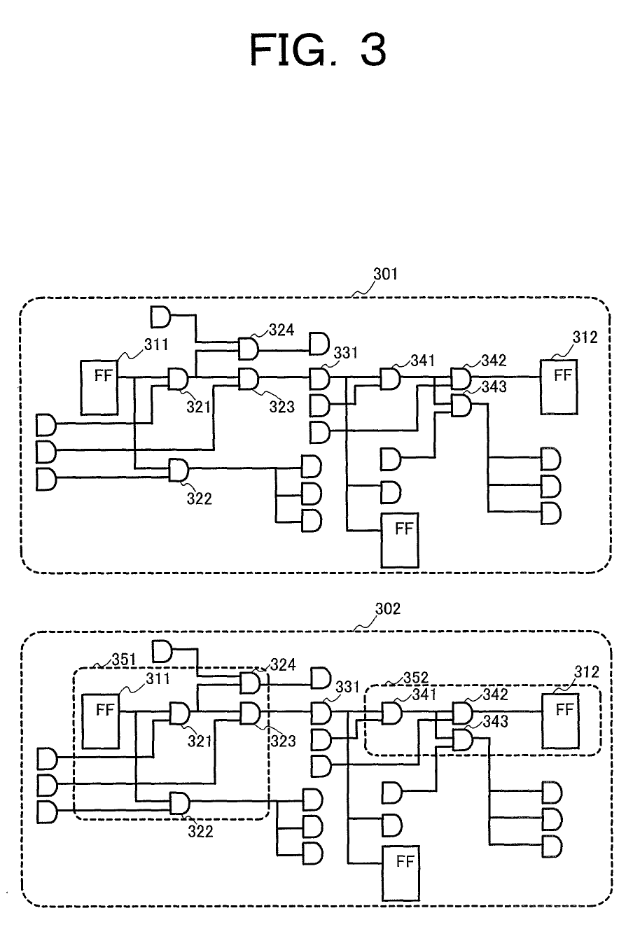

With reference to FIG. 3, the detailed description will be made of the adjacent placement process 211. In a logic circuit 301, a path from FF311 to FF312 is assumed to be the worst delay path. With the FF311 as the starting point, fan-out trace is performed toward FF312. A fan-out number of an output net of FF311 is 2, which satisfies the adjacent placement constraints (the maximum fan-out number is 2 or less).

Three pieces consisting of FF311 and cells 321 and 322 are assumed to be one group. Next, the fan-out number of output net of the cell 321 is also 2, and the adjacent placement constraints are satisfied, and therefore, since two pieces consisting of cells 323 and 324 can be also added to the group concerned, totaling 5 cells. Since from FF311 to cell 323, 324 run to three stages, the fan-out destination of the cell 323, 324 cannot be included in the group concerned.

On the other hand, since a fan-out number of output net of the cell 322 is 3 and does not satisfy the fan-out number of 2 or less, which are the adjacent placement constraints, the fan-out destination of the cell 322 cannot be included in the group concerned. As a result, as shown in the logic circuit 302, a group 351 consisting of five cells: cells 311, 321, 322, 323 and 324 can be obtained.

Next, a cell 331 on a violated path is selected. Since, however, a fan-out number of output net of the cell 331 is 3 and does not satisfy the fan-out number of 2 or less, which are the adjacent placement constraints, any group having the cell 331 as the starting point cannot be constituted.

Next, a cell 341 on a violated path is selected, and a group 352 consisting of four cells: cells 341, 342, 343 and 312 can be obtained as shown in the logic circuit 302 by using the same method as described above. In the foregoing, a process of a delay violated path in FF311 to FF312 is completed.

Next, the wire length of an internal net of groups 351 and 352 obtained is set to the short fixed length (it is assumed here that 0 has been designated) specified in the program controlling information file 114 for delay re-circulation. It is not necessary to perform this re-calculation in the entire logic circuit, but it can be performed only within a range to be affected by the wire length fixed. As a result of the delay re-calculation, a path having the heaviest degree of delay violation is selected, and the above-described adjacent placement process is performed again, and is repeated until any delay violated path disappears or until the adjacent placement process for the delay violated path selected is finished.

Adjacent Placement Process of Other Cells 212:

An object of this process is to reduce pin density for improving wiring characteristics by grouping those cells which have not been grouped in the adjacent placement process 211 for cells on critical paths. In this case, the cells are selected in order while fan-in trace with FF or the block output port as the starting point is being performed, and adjacent placement of the cells is instructed within such a range as to satisfy the adjacent placement constraints. In this case, the adjacent placement constraints have been given to the program controlling information file 114, and there are described a number of cells within one group, the upper limit of number of stages, the maximum fan-out number of nets within the group and the like as in the adjacent placement process 211. In this case, the adjacent placement constraints are assumed to be given in which the number of cells is 6 or less, the number of stages is three stages or less, the maximum fan-out number of net is 1 or less.

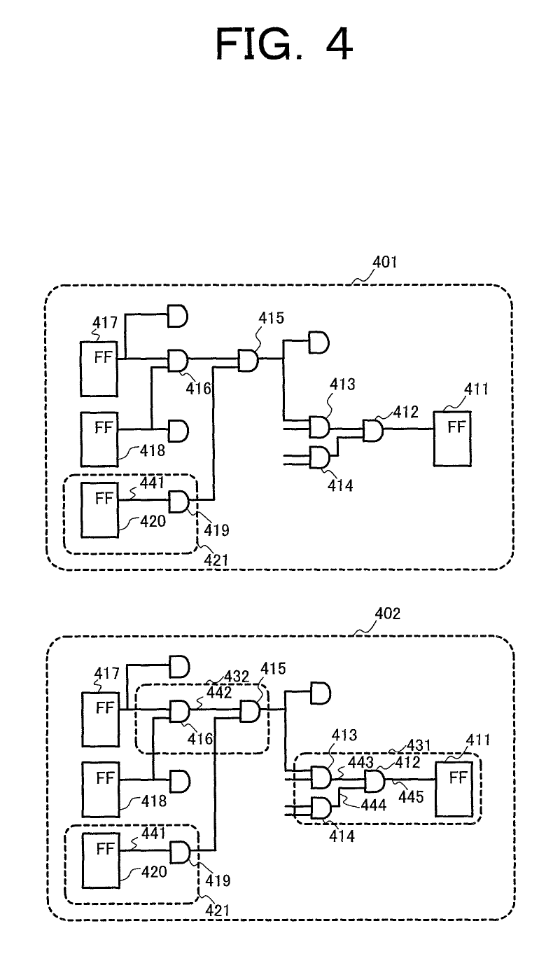

With reference to FIG. 4, the detailed description will be made of the adjacent placement process of other cells 212. In the logic circuit 401, a group 421 consisting of FF420 and a cell 419 is assumed to have been grouped in the adjacent placement process 211 for cells on critical paths.

First, in the logic circuit 401, the fan-in trace is started with FF411 as the starting point. Since a cell 412 of the fan-in of FF411 satisfies the adjacent placement constraints (maximum fan-out number is 1 or less) at fan-out number of 1, the FF411 and the cell 412 are set to the same group. Similarly, cells 413 and 414 can be included in the above-described group. FF411 to cell 413, 414 have three stages respectively, and fan-in trace having three or more stages cannot be performed because the adjacent placement constraints, in which the number of stages is three stages or less, are not satisfied. Therefore, a group 431 consisting of FF411, cells 412, 413 and 414 is constructed as shown in the logic circuit 402.

Next, fan-in trace with a cell 415 of the cell 413 on the input side as the starting point will be performed. As cells of the cell 415 on the input side, there are two cells 416 and 419. However, since it has been already included in the group 421, the cell 419 cannot be included in the same group as the cell 415. On the other hand, the cell 416 can be included in the same group as the cell 415.

Since an output net of FF417, which is a cell of the cell 416 on the input side, has a fan-out number of 2, and does not satisfy the adjacent placement constraints, the FF417 cannot be included in the same group as the cells 415 and 416. Therefore, as shown in the logic circuit 402, a group 432 consisting of the cells 415 and 416 is constructed. These processes will be performed over the entire logic circuit to proceed to the next process 213.

Driving Ability Optimizing Process 213:

A driving ability of cells grouped will be optimized. The driving ability is optimized for reduction of delay as a first object. Since reduced driving ability has effects that the chip area and the power consumption is further reduced, the optimization will be positively performed. On the other hand, since increased driving ability increases the chip area and the power consumption, it is necessary to increase by restricting only to a case where there is a delay reduction effect on critical paths. Hereinafter, the concrete description will be made of the driving ability optimizing process.

First, the driving ability of the cell at the input end of each group will be reduced. When the cell at the input end, on which attention has been focused, satisfies the following conditional expression:

Cin>2·Ron1·CLa/Ron0 (1)

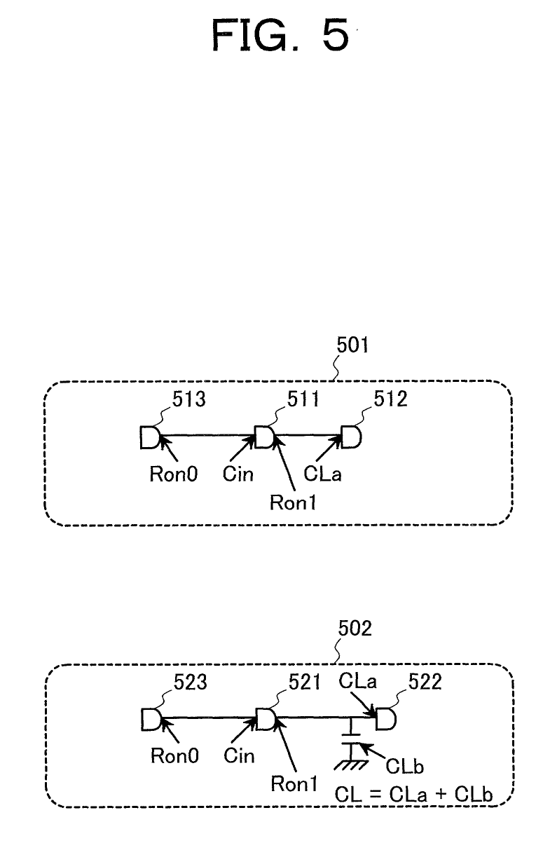

the driving ability will be reduced to one half.

where each variable in the above-described conditional expression (1) is such that in the circuit 501 shown in FIG. 5, input capacitance of a pin before the driving ability of the cell 511, to which attention has been focused, is changed is Cin, the output resistance is Ron1, the sum of input capacitance of a cell 512 of the cell 511 on the output side is CLa, and the output resistance of the input-side cell 513 of the cell 511 is Ron0.

When the driving ability of the cell 511 is reduced to one half, the above-described conditional expression (1) represents a case where the cell width becomes one half. This shows a condition that an output net-side delay increment Ron1·CL which has been caused when the input capacitance Cin becomes one half and the output resistance Ron1 becomes twice becomes smaller than an input net-side delay decrement Ron0·Cin/2. However, this is a conditional expression applicable only on critical paths, and the driving ability may be reduced within a range in which no delay violation occurs over the entire circuit with the exception of the critical paths.

Next, the driving ability of the cell at the output end of each group will be increased. The target cell is the cell on the delay violated path, and when the output resistance of the cell at the output end, to which attention has been focused, satisfies the following conditional expression:

Ron1<Ron0·Cin/(2CL) (2)

the driving ability will be increased to twice.

where each variable in the conditional expression (2) is such that in the circuit 502 shown in FIG. 5, input capacitance of a pin before the driving ability of the cell 521, to which attention has been focused, is changed is Cin, the output resistance is Ron1, a sum of input capacitance CLa of a cell 522 of the cell 521 on the output side is CLa and wire capacitance CLb of the output-side net of the cell 521 is CL (=CLa+CLb),and out put resistance of the input-side cell 523 of the cell 521 is Ron0.

When the driving ability of the cell 521 is increased to twice, the above-described conditional expression (2) represents a case where the cell width becomes twice. This shows a condition that an output net-side delay increment Ron1·CL which has been caused when the input capacitance Cin becomes twice and the output resistance Ron1 becomes one half becomes smaller than the input net-side delay decrement Ron0·Cin/2. However, a sum of wire capacitance of the output-side net of the cell 521 will be calculated assuming that wire length of the net concerned is equal to the virtual wire length.

In the foregoing examples, the description has been made of cases of one-stage increase (twice the driving ability) of the driving ability, and decrease (one half the driving ability), but increase and decrease of other magnifications are similarly possible.

In the foregoing, the cell grouping process 201 is completed. In the layout controlling information generating unit 103, a wire length budgeting process 202 is next performed, and thereafter, a layout unit 104 is performed, but before the description of the wire length budgeting process 202, the description will be made of the process of the layout unit 104 of a logic circuit which has been cell-grouped.

Layout Unit 104:

A logic circuit description file 115 which has been changed by the cell grouping process 201, and a layout program controlling information file 116 are inputted, and placement and routing will be performed in accordance with an adjacent placement instruction, which has been described in the layout program controlling information file 116, and wire length budget to be described later to output a layout data file 117.

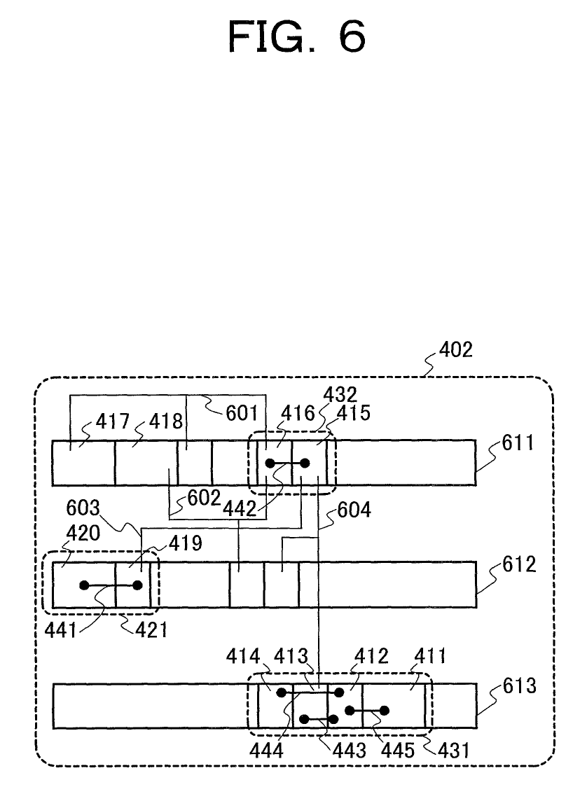

FIG. 6 shows layout result of the logic circuit 402 shown in FIG. 4. Cells in each cell group 421, 431, 432, which have been instructed to adjacent-place, will be placed adjacent to each other respectively. For example, cells 419 and 420 to be included in a cell group 421 are placed adjacent to each other on a cell column 612, and a connection between the cells 419 and 420 indicated by a net 441 is realized in local interconnect.

Similarly, the adjacent placement is realized on a cell column 613 for a cell group 431, and on a cell column 611 for a cell group 432 respectively. Any other wiring than between adjacent placement cells is realized by ordinary cell-to-cell wiring as indicated by reference numerals 601 to 604. In the foregoing, the description on the cell grouping process is completed.

Wire Length Budgeting Process 202:

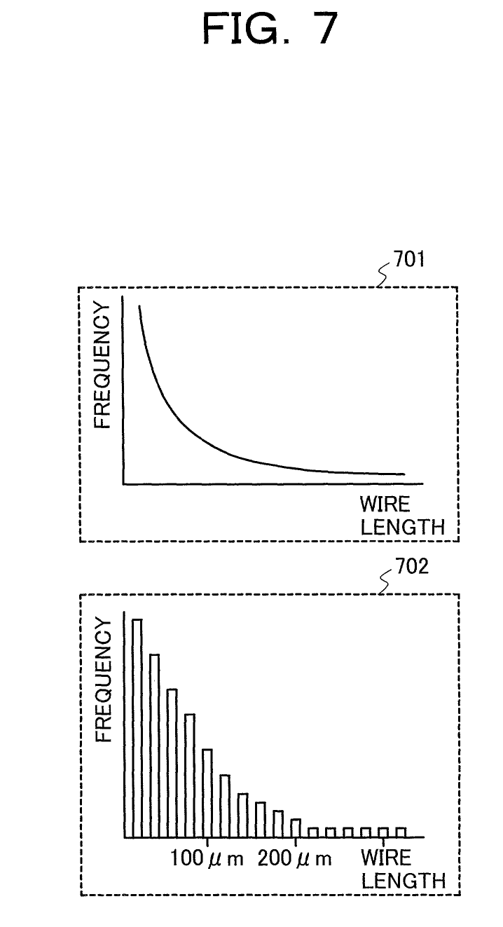

In the wire length budgeting process, wire length budget is given to each net of the logic circuit so as to have substantially same distribution as statistical wire length distribution. FIG. 7 shows wire length distribution of a net in the logic circuit. Statistical distribution 701 is given by the program controlling information file 114, and shows times of the net for each wire length. In the wire length budgeting process 202, an increment of the wire length to be given is arranged to be given from the program controlling information file 114 in advance, and the wire length distribution is prepared again at that increment. When the increment in the wire length is, for example, 20 μm, that is, when the wire length to be given as the budget is set to 20 μm, 40 μm, 60 μm, . . . , a total of times when the wire length of the statistical distribution 701 is within a range of 0 to 20 μm or less is set to times of the wire length 20 μm, and the total of times when the wire length of the statistical distribution 701 is within a range of 20 μm and over to 40 μm incl. is set to times of the wire length 40 μm. New times will be calculated in this manner, and new distribution 702 will be prepared. In the wire length budgeting process 202, the process will be performed based on this new wire length distribution 702.

Next, a process of giving a short wire length to a net on a severe delay path, and further a process of giving a long wire length to the remaining net will be performed. Hereinafter, the description will be made of these processes.

Short Wire Length Generation Process:

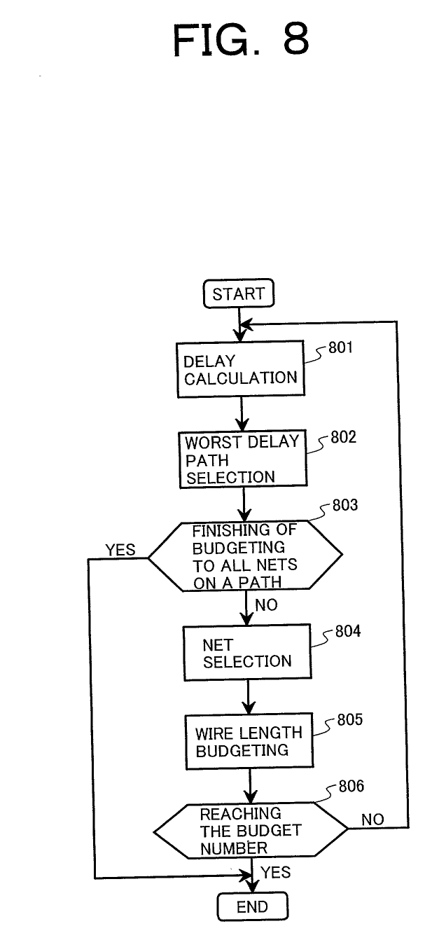

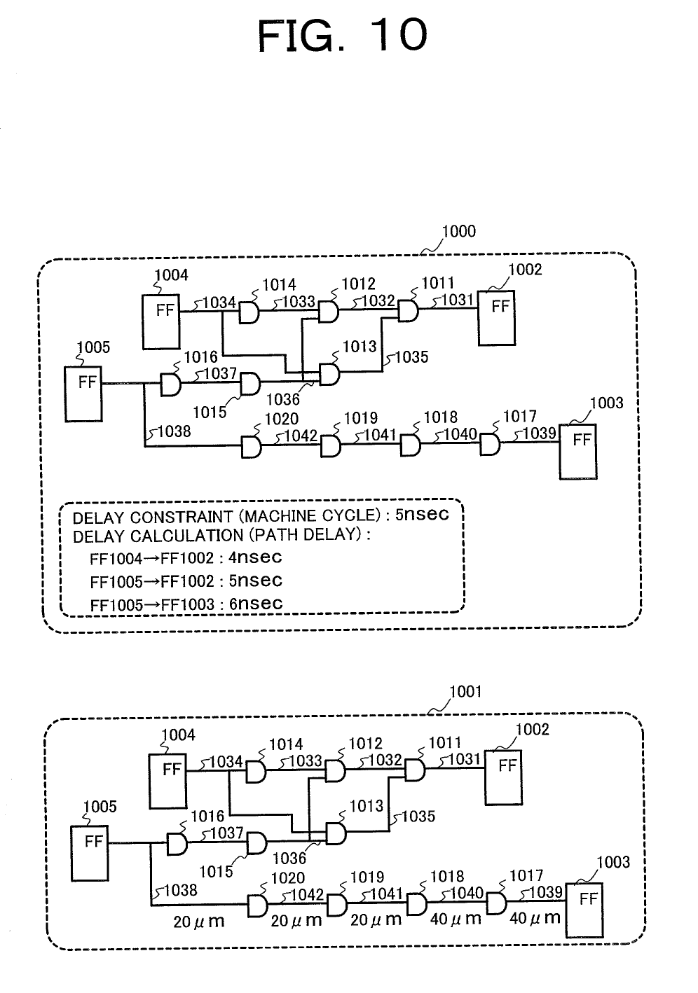

FIG. 8 is a flow chart showing a process of giving a short wire length. Hereinafter, the description will be made of the logic circuit shown in FIG. 10 as an example.

Delay Calculation 801:

Concerning a net within a group which has been instructed adjacent placement by the cell grouping process, fixed wire length (generally 0) is used, concerning a net, to which wire length budget has been given by the following process, wire length given is used, and concerning other nets, the virtual wire length is used, to perform respective delay calculations for proceeding to the next process 802. In this respect, in a logic circuit 1000 of FIG. 10, delay of a path from FF1004 to FF1002 is assumed to be 4 nsec, delay of a path from FF1005 to FF1002 is assumed to be 5 nsec, and delay of a path from FF1005 to FF1003 is assumed to be 6 nsec. Also, the delay constraints (machine cycle) is assumed to be 5 nsec.

Worst Delay Path Selection 802:

Based on the above-described delay calculation result, a path having worst delay value is selected to proceed to the next process 803. In the logic circuit 1000, worst delay of a path from FF1005 to FF1003 is 6 nsec.

Judgment Whether or Not Budgeted for All Nets on Path 803:

If the judgment result is “YES”, the process of giving short wire length will be completed. If “NO”, the sequence will proceed to Process 804. In the case of the logic circuit 1000, since no wire length budget has been yet given to the nets on the path from FF1005 to FF1003, the sequence will proceed to Process 804.

Net Selection 804:

From nets on a path selected, one net is selected to proceed to the next Process 805. As the selection standard, weighting is effected on the following conditions in nets, to which no wire length has been given yet to select a net with the greatest weight. As regards the weighting, a weight function will be rendered capable of being defined from the program controlling information file 114 in such a manner that weight of a net with high fan-out number F becomes great, weight of an output net of a cell with small driving ability R becomes great, and weight becomes great when delay violated paths including the net concerned are large in number P.

In the present embodiment, the weight function is set to F·P/R. When there are a plurality of nets with the same weight, a net closer to the input side is preferentially selected. In the case of the logic circuit 1000, in nets 1038 to 1042 on paths FF1005 to FF1003, only the net 1038 has 2 and others have 1 in fan-out number F, all delay violated paths have 1 in number P because the delay violated path is only the path concerned, and all has the same driving ability R if cells on the path concerned has the same driving ability. Therefore, since only the net 1038 is larger than other nets 1039 to 1042, the net 1038 will be selected.

Wire Length Budgeting 805:

Within the scope in which times of wire length given based on the wire length distribution 702 do not exceed the times of the distribution diagram, wire length as short as possible is given to proceed to the next Process 806. In the logic circuit 1000, the shortest wire length 20 μm is given to the net 1038.

Judgment for Reaching the Budget Number 806:

It is judged whether or not the budget number of a net of giving short wire length budget has been reached, and if “YES”, the process will be completed, while if “NO”, the sequence will return to the delay calculation 801 process. The budget number is given from the program controlling information file 114. In this case, if the budget number of the logic circuit 1000 is assumed to be 5, the sequence will return to the delay calculation 801 because the budget is given to one net.

Delay Calculation 801:

Delay calculation on which wire length 20 μm given to the net 1038 is reflected will be performed. As a result, in the logic circuit 1000, it is assumed that delay of a path from FF1004 to FF1002 is 4 nsec, delay of a path from FF1005 to FF1002 is 4.7 nsec, and delay of a path from FF1005 to FF1003 is 5.7 nsec.

Since the delay of a path from FF1005 to FF1003 is worst, this path is selected in the worst delay path selection 802 to repeat the above-described process. Final result of the process of giving short wire length to the logic circuit 1000 is shown in FIG. 10 as a logic circuit 1001. To nets 1038 to 1042, wire length budget 20 μm, 40 μm, 40 μm, 20 μm and 20 μm will be given respectively.

In this case, when it is assumed to be necessary to change wire length between a cell 1017 and FF1003 to 20 μm because of small driving ability of a cell 1017 in a logic circuit 1001 in, for example, FIG. 10, a net 1039 is selected on the display of a graphic terminal 121 through the use of a pointing device such as a mouse or a keyboard. Next, a numerical value is inputted from the keyboard, or wire length corresponding to wire length 20 μm on wire length distribution 702 shown in a histogram of FIG. 7 is selected through the use of the pointing device. Thereby, wire length budget is given through a terminal 121. Thus, the user is capable of designating the wire length budget to a part of net in the logic circuit in an interactive manner. In other words, an automatic logic design supporting apparatus is provided with a graphic user interface, whereby an interactive wire length budgeting process can be performed. Then, a process of giving long wire length will be performed.

Long Wire Length Generation Process:

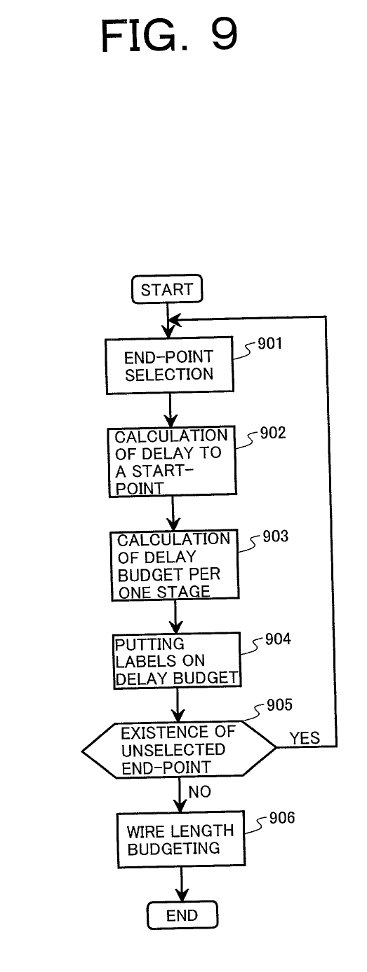

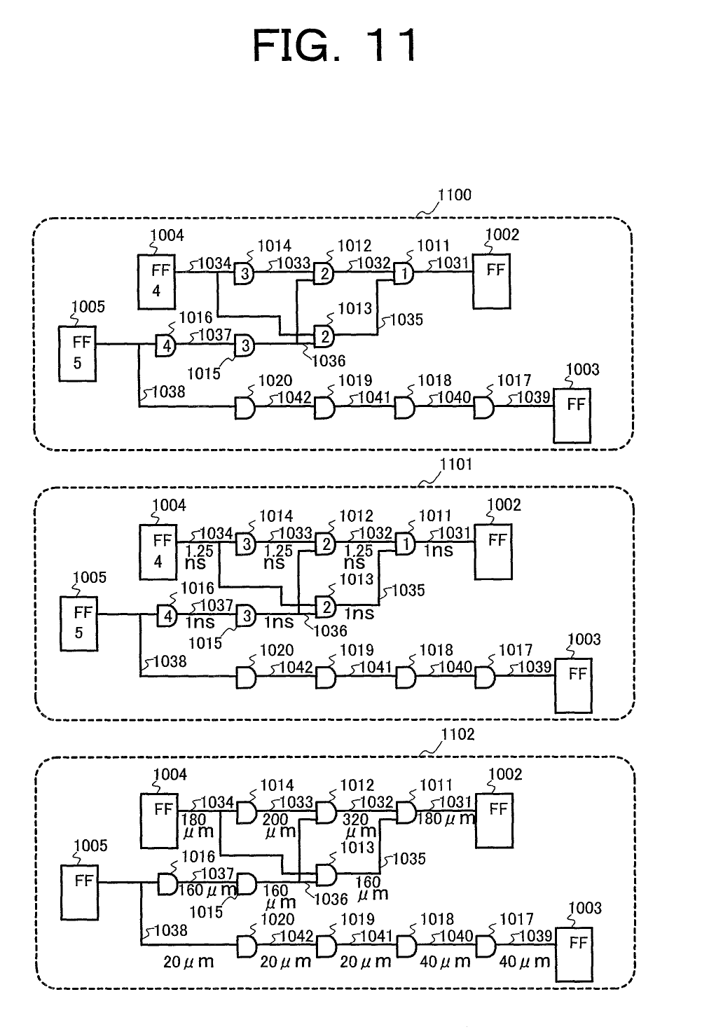

FIG. 9 is a flow chart showing the long wire length generation process. Hereinafter, the description will be made based on the example of FIG. 11. FIG. 11 is result after the process of giving long wire length to the logic circuit of FIG. 10 is performed.

End-Point Selection 901:

An end-point of the path is selected from the logic circuit. In this case, the end-point is FF or an output port of the logic circuit. An order of end-point selection is optional. In the example of the present embodiment, the budgeting result is not affected by the order of selection. In the logic circuit 1100 of FIG. 11, as the end-point, there are two points: FF1002 and FF1003. First, FF1002 will be selected.

Calculation of Delay to A Start-Point 902:

Fan-in trace will be performed from an end-point selected to a start-point of the path. Worst delay of the cell traced to the end-point will be calculated to proceed to the next Process 903. In this case, the start-point is FF or an input port of the logic circuit. In the logic circuit 1100 of FIG. 11, fan-in trace will be performed from FF1002 selected as the end-point to the start-point FF1004, FF1005, and in each cell 1011 to 1016, 1004 and 1005, the respective numbers of stage become 1, 2, 2, 3, 3, 4, 4 and 5 respectively as shown in the logic circuit 1100.

Calculation of Delay Budget Per One Stage 903:

Delay budget per one stage of a cell of a path traced in the process of calculation of delay to a start-point 902 will be calculated to proceed to the next Process 904. In this case, the delay budget per one stage of a cell is (delay constraints)/(number of stages of path). In the logic circuit 1100 of FIG. 11, since the number of stages of a path in FF1004 to FF1002 is four stages, delay budget per one stage of a cell is 5 nsec/4 stages=1.25 nsec, and since the number of stages of a path in FF1005 to FF1002 is five stages, delay budget per one stage of a cell is 5 nsec/5 stages=1 nsec.

Putting Labels on Delay Budget 904:

Labels on delay budget will be put on each net fan-in traced in the calculation of delay to a start-point 902 to proceed to the next Process 905. This gives a delay budget of the path including the start-point to the net while trace is being performed from each start-point toward the end-point. In the case where a net, to which attention is focused, is included in a plurality of paths having different start-points, the minimum delay budget will be selected. For a net, to which wire length has been already given in the short wire length generation process, the label will be removed finally.

A logic circuit 1101 is obtained by putting labels on the logic circuit 1100. For nets 1031, 1035, 1036 and 1037, the label becomes 1nsec respectively, and for nets 1032, 1033 and 1034, the label becomes 1.25 nsec respectively.

Judgment Whether or Not There Is Any Unfinished End-Point 905:

It is judged whether or not there is any unfinished end-point, and if “YES”, the sequence will return to the Process 901, while if “NO”, the operation will be completed. In the logic circuit 1101, since FF2003 is unfinished, the sequence will return to the Process 901.

End-Point Selection 901:

The FF1003 is selected as the end-point. Although the detailed description on the subsequent processes will be omitted, all nets on paths from FF1005 to FF1003 have been already given wire length in the short wire length generation process, and therefore, no labels can be put. Next, the description will be made of wire length budgeting 906.

Wire Length Budgeting 906:

Nets, on which labels have been put, will be sorted in decreasing order of size of label, and wire length will be allocated in decreasing order based on the wire length distribution 702. In the logic circuit 1101, longest wire length 320 μm will be first given to a net 1032, and hereinafter, long wire length will be given to each net as shown in a logic circuit 1102.

In the foregoing, the cell grouping process 201 and the wire length budgeting process 202 are completed, and their results will be outputted to the logic circuit description file 115 and the layout program controlling information file 116 to complete a process of the layout controlling information generating unit 103.

Layout Unit 104:

With the logic circuit description file 115 and the layout program controlling information file 116 as inputs placement and routing will be performed in accordance with adjacent placement instruction and wire length budget which have been described in the layout program controlling information file 116 to output a layout data file 117. Since an example of layout process using result of the cell grouping process 201 has already been described, the description will be made of an example of layout process using the result of the wire length budgeting process 202 here.

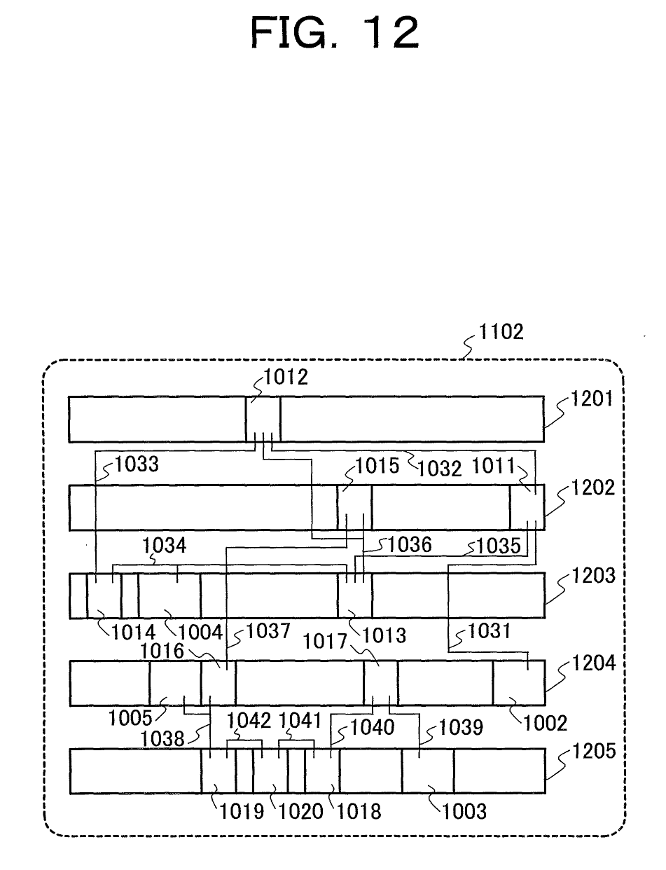

FIG. 12 shows layout result of a logic circuit 1102. Each cell 1002 to 1005 and 1011 to 1020 will be placed and routed on cell column 1201 to 1205 so as to satisfy wire length budget given to each net 1031 to 1042. Since wire length budget of a net 1042 is 20 μm as shown in, for example, FIG. 11, cells 1019 and 1020 at both ends thereof will be placed in close proximity to each other. Also, since wire length budget of the net 1033 is 200 μm, cells 1012 and 1014 at both ends thereof can be placed spaced apart within such a scope as to satisfy the budget.

As described above, an automatic logic design supporting method of the invention is to place a plurality of cells within a logic circuit adjacent to one another in a logic circuit after logic synthesis for performing a cell grouping process, which generates adjacent placement instruction for realizing wiring between cells adjacent to each other in local inter-connect. Further, a wire length budgeting process for giving wire length budget will be performed so as to be able to satisfy delay constraints in nets within the logic circuit so that placement and routing will be performed in accordance with these adjacent placement instruction and wire length budget.

In order to obtain an automatic logic design supporting apparatus for realizing this automatic logic design supporting method, it can be provided with: logic design input means for inputting function description of logic circuits; logic synthesis means for performing logic synthesis from the function description; layout program controlling information generating means for generating layout controlling information for laying out the logic circuit so as to be able to satisfy the delay constraints; and layout means for laying out the logic circuit based on the layout controlling information. Further, if there are provided a display unit for displaying a logic circuit diagram and a wire length distribution diagram and a graphic user terminal having a pointing device such as a mouse and a keyboard input device, it will be possible to designate wire length budget to some nets within the logic circuit through this terminal in an interactive manner.

According to the present invention, it is possible to lay out a circuit as a result of the logic synthesis so as to be able to satisfy the delay constraints without changing the logic structure. As a result, it is possible to avoid re-designing of the previous process of design, and this leads to the effect that the number of design man-hour of LSI can be reduced.

In the foregoing, the description has been made of preferred embodiments of the present invention, but the present invention is not limited to the above-described embodiments. It is further understood by those skilled in the art that various changes and modifications may be made in the invention without departing from the spirit and scope thereof.

What is claimed is:

1. An automatic logic design supporting method, comprising:
a logic design input process for inputting function description of a logic circuit;
a logic synthesis process for synthesizing a logic circuit from said function description;
a layout program controlling information generating process for generating layout controlling information for laying out said logic circuit so as to be able to satisfy delay constraints; and
a layout process for laying out said logic circuit based on said layout program controlling information.

2. An automatic logic design supporting method according to claim 1, wherein said layout program controlling information generating process includes a cell grouping process for placing a plurality of cells within a logic circuit to be adjacent to each other, and for generating an adjacent placement instruction for realizing wiring between cells adjacent to each other in local inter-connect.

3. An automatic logic design supporting method according to claim 1 or 2, wherein said layout program controlling information generating process includes a wire length budgeting process for giving a wire length budget to a net within said logic circuit to lay out in such a manner that said layout process becomes equal to or less than the wire length given to said net.

4. An automatic logic design supporting method according to claim 2, wherein said cell grouping process extracts a partial circuit, which conforms to a cell grouping rule instructed from the outside, from within the logic circuit in accordance with said rule for generating an adjacent placement instruction to said partial circuit.

5. An automatic logic design supporting method according to claim 2, wherein said cell grouping process includes a process for changing a driving ability of a cell which has further received an adjacent placement instruction under a condition to satisfy the delay constraints.

6. An automatic logic design supporting method according to claim 3, wherein said wire length budgeting process allots such a wire length budget as to satisfy the delay constraints to all nets or some nets within the logic circuit.

7. An automatic logic design supporting method according to claim 3, wherein said wire length budgeting process allots a wire length budget to all nets within the logic circuit so as to follow designated wire length distribution.

8. An automatic logic design supporting method according to claim 3, wherein said wire length budgeting process is capable of designating a wire length budget to some nets within the logic circuit in an interactive manner.

9. An automatic logic design supporting apparatus, comprising:
logic design input means for inputting function description of a logic circuit;
logic synthesis means for synthesizing a logic circuit from said function description;
layout program controlling information generating means for generating layout program controlling information for laying out said logic circuit so as to be able to satisfy delay constraints; and
layout means for laying out said logic circuit based on said layout program controlling information.

10. An automatic logic design supporting apparatus according to claim 9, further comprising a graphic user interface consisting of a display device for displaying a logic circuit diagram and a wire length distribution diagram, and an input device such as a keyboard and a mouse for designating the wire length.

11. A semiconductor device obtained by designing through the use of an automatic logic design apparatus according to claim 9.
